(19) United States
(12) Patent Application Publication
(10) Pub. No.: US 2026/0222650 A1
(43) Pub. Date: Jul. 30, 2026

(54) DISPLAY DEVICE AND SPECIFIC PLATFORM APP USE INDUCEMENT METHOD THEREOF

(71) Applicant: LG ELECTRONICS INC., Seoul (KR)

(72) Inventor: Kyung Ryun LEE, Seoul (KR)

(73) Assignee: LG ELECTRONICS INC., Seoul (KR)

(21) Appl. No.: 19/143,625

(22) PCT Filed: Jan. 2, 2023
(86) PCT No.: PCT/KR2023/000029

§ 371 Date: Jun. 26, 2025

(51) Int. Cl. H04N 21/4722; H04N 21/422; H04N 21/431

(52) U.S. Cl. CPC H04N 21/4722; H04N 21/42204; H04N 21/4316

(57) ABSTRACT

The present disclosure relates to a display device capable of inducing a user to use a specific platform app, and a recommended platform app use inducement method thereof, wherein the display device may: when the display device is connected to an external device, execute an app of the external device to provide content; obtain app execution information of the external device; analyze usage of an app identical to an app on a specific platform on the basis of the app execution information of the external device; and control a nudge generation unit to generate a nudge which induces the use of the app on the specific platform when the usage of the app identical to the app on the specific platform is greater than or equal to a reference usage.

### TECHNICAL FIELD

The present disclosure relates to a display device capable of inducing a user to use a specific platform app and a method for inducing the use of a recommended platform app thereof.

### BACKGROUND ART

In general, a display device is a device that has the function of receiving, processing, and displaying images that can be viewed by a user. A display device receives a broadcast signal selected by a user from among broadcast signals transmitted from a broadcasting station, separates an image signal from the received signal, and then displays the separated image signal on a display.

In recent years, due to the development of broadcasting technology and network technology, the functions of display devices have become considerably more diverse, and the performance of the devices has also improved accordingly. In other words, display devices have evolved to provide users with not only simply broadcasted content, but also various other content.

For example, the display device can provide not only programs received from broadcasting stations, but also game play, music appreciation, Internet shopping, and customized information using various applications. In order to perform these expanded functions, the display device is basically connected to other devices or networks using various communication protocols, and can provide a ubiquitous computing environment to the user. In other words, the display device has evolved into a smart device that enables connectivity to a network and ubiquitous computing.

Meanwhile, the display device can provide content using an app installed on an external device when the external device is connected.

In this case, the display device only acts as a monitor, providing content through an external platform app installed on an external device, rather than using a specific platform app stored in the internal memory.

In this way, if the display device only functions as a monitor, it is disadvantageous in securing parameters for users of a specific platform, and the image quality services provided to users may deteriorate because it cannot provide optimal image quality services through apps of a specific platform.

Therefore, in the future, it is necessary to develop a display device that can provide optimal image quality service by inducing users to use apps for a specific platform.

### DISCLOSURE

### Technical Problem

An object of the present disclosure is to solve the above-mentioned problems and other problems.

An object of the present disclosure is to provide a display device capable of providing optimal image quality service by analyzing the usage of the same app as that of a specific platform based on app execution information of an external device and generating a nudge to induce the use of an app of a specific platform, and a method for inducing the use of a recommended platform app thereof.

### Technical Solution

According to an embodiment of the present disclosure, a display device includes a communication part connected to an external device; a nudge generation part generating a nudge that induces the use of an app of a specific platform; and, a processor controlling the nudge generation part, in which the processor, when connected to the external device, may execute the app of the external device to provide content, obtains app execution information of the external device, analyze the usage of the same app as the app of the specific platform based on the app execution information of the external device, and control the nudge generation part to generate a nudge that induces the use of the app of the specific platform if the usage of the same app as the app of the specific platform is equal to or greater than a reference usage.

According to an embodiment of the present disclosure, a method for inducing use of a specific platform app of a display device may include connecting to an external device; providing image content by executing an app of the external device; obtaining app execution information of the external device; analyzing the usage of an app identical to the app of the specific platform based on the app execution information of the external device; and if the same app usage as the app on the specific platform is equal to or greater than the reference usage, generating a nudge that induces use of an app of the specific platform.

### Advantageous Effect

According to one embodiment of the present disclosure, a display device can provide an optimal image quality service by analyzing the usage of an app identical to an app of a specific platform based on app execution information of an external device and generating a nudge to induce the use of an app of a specific platform.

In addition, the present disclosure can advantageously secure a user parameter of a specific platform, promote the business viability of a specific platform, secure diverse customers, and provide advertising effects for related products.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing a remote control device according to an embodiment of the present disclosure.

FIG. 5 is a block diagram illustrating a display device according to one embodiment of the present disclosure.

FIGS. 6 to 8 are views for explaining a process for inducing use of a specific platform app of a display device according to an embodiment of the present disclosure.

FIGS. 9 to 12 are views for explaining a process of obtaining external device app execution information of a display device according to an embodiment of the present disclosure.

FIG. 13 is a view for explaining a process of displaying a platform-specific app information provision window of a display device according to one embodiment of the present disclosure.

FIG. 14 is a view for explaining a process of displaying a platform-specific image information provision window of a display device according to one embodiment of the present disclosure.

FIG. 15 is a view for explaining a process of displaying a specific platform promotional message of a display device according to one embodiment of the present disclosure.

FIG. 16 is a view for explaining a process of providing continuous viewing image content through execution of a specific platform app of a display device according to an embodiment of the present disclosure.

FIG. 17 is a view for explaining a process of displaying a specific platform app experience provision window of a display device according to one embodiment of the present disclosure.

FIG. 18 is a flowchart illustrating a process for inducing use of a specific platform app of a display device according to an embodiment of the present disclosure.

### BEST MODE

Hereinafter, embodiments disclosed in this specification is described with reference to the accompanying drawings, and the same or corresponding components are given with the same drawing number regardless of reference number, and their duplicated description will be omitted. The suffixes “module” and “part” for components used in the description below are assigned or mixed in consideration of easiness in writing the specification and do not have distinctive meanings or roles by themselves. Moreover, detailed descriptions related to well-known functions or configurations will be ruled out in order not to unnecessarily obscure subject matters of the present disclosure. However, this does not limit the present disclosure within specific embodiments and it should be understood that the present disclosure covers all the modifications, equivalents, and replacements within the idea and technical scope of the present disclosure.

It will be understood that although the ordinal numbers such as first and second are used herein to describe various elements, these elements should not be limited by these numbers. The terms are only used to distinguish one component from other components.

It will also be understood that when an element is referred to as being “connected to” or “engaged with” another element, it can be directly connected to the other element, or intervening elements can also be present. It will also be understood that when an element is referred to as being ‘directly connected to’ another element, there is no intervening elements.

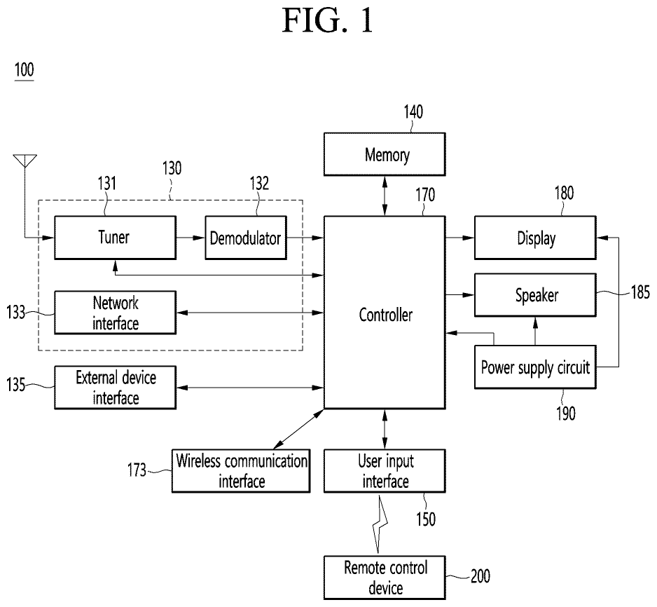

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input unit 150, a control unit 170, a wireless communication interface unit 173, a display unit 180, an audio output unit 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The network interface 133 may provide an interface for connecting the display device 100 to a wired/wireless network comprising internet network. The network interface 133 may transmit or receive data to or from another user or another electronic device through an accessed network or another network linked to the accessed network.

The network interface unit 133 may access a predetermined webpage through an accessed network or another network linked to the accessed network. That is, the network interface unit 133 may transmit or receive data to or from a corresponding server by accessing a predetermined webpage through the network.

The network interface unit 133 may receive content or data provided from a content provider or a network operator. That is, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display unit 180. A sound signal of an external device inputted through the external device interface unit 135 may be outputted through the audio output unit 185.

An external device connectable to the external device interface unit 135 may be one of a set-top box, a Blu-ray player, a DVD player, a game console, a sound bar, a smartphone, a PC, a USB Memory, and a home theater system but this is just exemplary.

Additionally, some content data stored in the display device 100 may be transmitted to a user or an electronic device, which is selected from other users or other electronic devices pre-registered in the display device 100.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (e.g., video files, still image files, music files, document files, application files, etc.) stored in the storage unit 140, and may provide the content files to a user.

The user input unit 150 may transmit signals input by a user to the control unit 170, or may transmit signals from the control unit 170 to a user. For example, the user input unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input unit 150 may transmit, to the control unit 170, control signals input from local keys (not shown) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output unit 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input unit 150, and may access the network to download a desired application or application list into the display device 100.

The control unit 170 may output channel information selected by a user together with the processed image or voice signals through the display unit 180 or the audio output unit 185.

In addition, the control unit 170 may output image signals or voice signals of an external device such as a camera or a camcorder, which are input through the external device interface unit 135, through the display unit 180 or the audio output unit 185, according to an external device image playback command received through the user input unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication part 173 may perform wired or wireless communication with an external device. The wireless communication part 173 may perform short-range communication with an external device. For this, the wireless communication part 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication part 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication part 173 may detect (or recognize) a wearable device capable of communication around the display device 100. Furthermore, if the detected wearable device is a device authenticated to communicate with the display device 100, the control unit 170 may transmit at least part of data processed in the display device 100 to the wearable device through the wireless communication part 173. Therefore, a user of the wearable device may use the data processed by the display device 100 through the wearable device.

The voice acquisition unit 175 may obtain audio. The voice acquisition unit 175 may include at least one microphone (not shown) and may obtain audio around the display device 100 through the microphone (not shown).

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output unit 185.

The audio output unit 185 receives the audio-processed signal from the control unit 170 to output an audio signal.

The power supply unit 190 supplies the corresponding power to the entire display device 100. Particularly, power may be supplied to the control unit 170 that is capable of being implemented in the form of a system on chip (SOC), the display unit 180 for displaying an image, the audio output unit 185 for outputting audio, and the like.

Specifically, the power supply unit 190 may include a converter that converts AC power to DC power and a DC/DC converter that converts a level of the DC power.

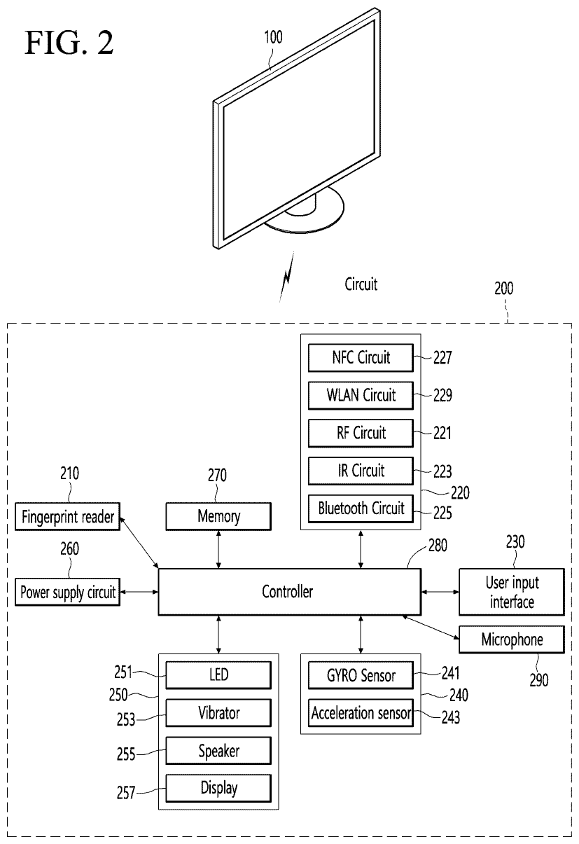

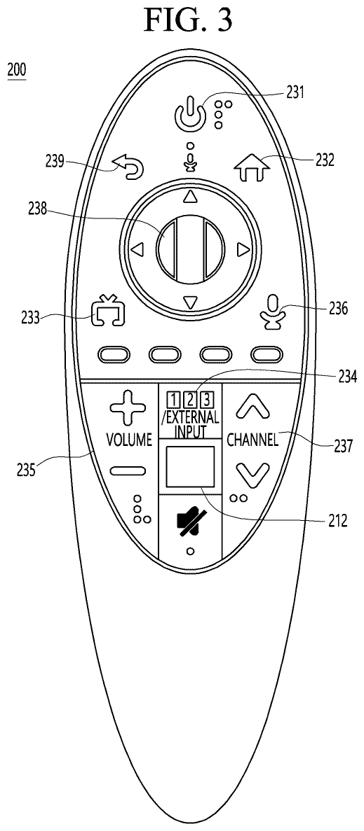

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication part 220, a user input unit 230, a sensor unit 240, an output unit 250, a power supply unit 260, a storage unit 270, a control unit 280, and a sound acquisition unit 290.

Referring to FIG. 2, the wireless communication part 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication reference, and an IR module 223 capable of transmitting or receiving signals to or from the display device 100 according to an IR communication reference. In addition, the remote control device 200 may include a Bluetooth module 225 capable of transmitting or receiving signals to or from the display device 100 according to a Bluetooth communication reference. In addition, the remote control device 200 may include an NFC module 227 capable of transmitting or receiving signals to or from the display device 100 according to an NFC communication reference, and a wireless LAN (WLAN) module 229 capable of transmitting or receiving signals to or from the display device 100 according to a WLAN communication reference.

In addition, the remote control device 200 may transmit signals containing information on the movement of the remote control device 200 to the display device 100 through the wireless communication part 220.

Moreover, the remote control device 200 may receive signals transmitted from the display device 100 through the RF module 221 and if necessary, may transmit a command for power on/off, channel change, and volume change to the display device 100 through the IR module 223.

The user input unit 230 may be configured with a keypad, a button, a touch pad, or a touch screen. A user may operate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation. The power button 231 may be a button for turning on/off the power of the display device 100. The home button 232 may be a button for moving to the home screen of the display device 100. The live button 233 may be a button for displaying live broadcast programs. The external input button 234 may be a button for receiving an external input connected to the display device 100. The volume control button 235 may be a button for controlling a volume output from the display device 100. The voice recognition button 236 may be a button for receiving user's voice and recognizing the received voice. The channel change button 237 may be a button for receiving broadcast signals of a specific broadcast channel. The OK button 238 may be a button for selecting a specific function, and the back button 239 may be a button for returning to a previous screen.

FIG. 2 is described again.

If the user input unit 230 includes a touch screen, a user may touch a soft key of the touch screen to input a command relating to the display device 100 to the remote control device 200. In addition, the user input unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output unit 250 may output image or voice signals in response to the operation of the user input unit 230, or may output image or voice signals corresponding to signals transmitted from the display device 100. A user may recognize whether the user input unit 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication part 220.

Additionally, the power supply unit 260 supplies power to the remote control device 200 and if the remote control device 200 does not move for a predetermined time, stops the power supply, so that power waste may be reduced. The power supply unit 260 may resume the supply of power if a predetermined key provided at the remote control device 200 is operated.

The storage unit 270 may store various kinds of programs and application data required to control or operate the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input unit 230 or a signal corresponding to the movement of the remote control device 200 sensed by the sensor unit 240 to the display device 100 through the wireless communication part 220.

In addition, the sound acquisition unit 290 of the remote control device 200 may obtain voice.

The sound acquisition unit 290 may include at least one microphone and obtain voice through the microphone.

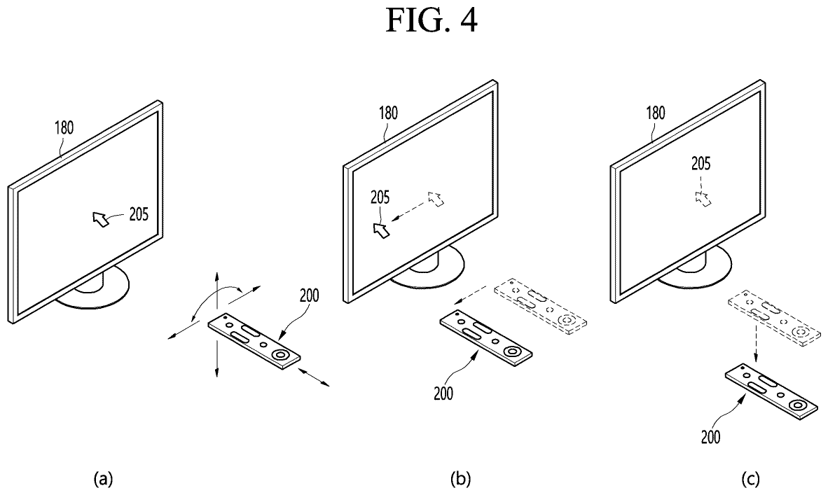

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as shown in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. That is, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

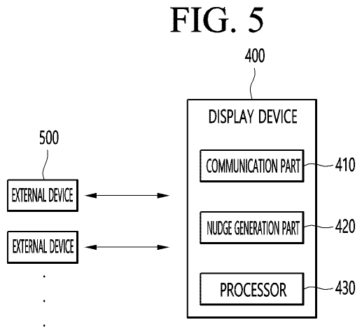

FIG. 5 is a block diagram illustrating a display device according to one embodiment of the present disclosure.

As illustrated in FIG. 5, the display device 400 of the present disclosure may include a communication part 410 connected to an external device 500, a nudge generation part 420 that generates a nudge that induces the use of an app of a specific platform, and a processor 430 that controls the nudge generation part 420.

Here, the external device 500 may include a STB (Set Top Box) and an OTT (Over The Top) device, but this is only an example and is not limited thereto.

Additionally, an external device 500 can be connected to an external server and provide content through an app on an external platform.

Next, the processor 430 can control the nudge generation part 420 to generate a nudge that executes an app of the external device 500 when connected to the external device 500 to provide content, obtains app execution information of the external device 500, analyzes the usage of the same app as the app of a specific platform based on the app execution information of the external device 500, and induces the use of the app of the specific platform if the usage of the same app as the app of the specific platform is equal to or greater than a reference usage.

Here, when providing content, the processor 430 can check whether there is an app execution request from the external device 500 when connected to the external device 500, and if there is an app execution request from the external device 500, execute the app of the external device 500, and provide content on the display screen through the app of the external device 500.

In one embodiment, when obtaining app execution information of an external device 500, if the external device 500 is connected to the same network as the display device 400, the processor 430 may obtain and store app history information of the external device 500 through an IP (Internet Protocol) network, and obtain app execution information of the external device 500 based on the app history information.

Here, the processor 430 can obtain app history information including an external device name, running app identification information, app execution count information, and app execution time information, but this is only an example and is not limited thereto.

Additionally, the processor 430 can obtain app history information of an external device 500 at preset intervals.

As another embodiment, when obtaining app execution information of an external device 500, the processor 430 can provide a content image through an app of the external device 500, and when the external device 500 recognizes the content image and extracts a feature of a specific app from the content image, obtain and store app history information executed by the user based on the extracted feature of the specific app, and obtain app execution information of the external device 500 based on the app history information.

Here, when obtaining app history information executed by the user, the processor 430 can check whether a feature of a specific app is extracted through content image recognition of an external device 500, and when extracting a feature of a specific app, determine that a specific app is executed, and obtain and store app history information for a specific app.

For example, a feature of a particular app may include identifying information about the executing app included within the content image.

In addition, the processor 430 can check whether an image analysis function of the external device 500 exists, and if an image analysis function of the external device 500 exists, can check whether features of a specific app are extracted through content image recognition of the external device 500.

Next, the processor 430 can obtain installation function information from the external device 500 and check whether the image analysis function of the external device 500 exists based on the installation function information.

As another embodiment, when obtaining app execution information of an external device 500, the processor 430 may provide a content image through an app of the external device 500, recognize the content image and extract identification information from the content image, obtain and store app history information executed by the user based on the extracted identification information, and obtain app execution information of the external device 500 based on the app history information.

Here, the processor 430 can recognize a content image using an ACR (Automatic Content Recognition) algorithm and extract identification information from the recognized content image.

For example, the processor 430 can extract identification information from a content image using a watermarking method or a fingerprinting method.

Additionally, the processor 430 can extract identification information including a content-specific watermark from the content image using a watermarking method.

Additionally, the processor 430 can extract identification information including unique identification values and feature points of the content from the content image using a fingerprinting method.

Next, when analyzing app usage, the processor 430 can check whether an app identical to an app of a specific platform exists in the app execution information of the external device 500, and if an identical app exists, extract the number of executions and execution time for the identical app from the app execution information of the external device 500, and analyze the usage of the identical app based on the number of executions and execution time for the identical app.

Next, the processor 430 can control the generation of a nudge when an app of an external device identical to an app of a specific platform is executed equal to or more than a reference number of times or for equal to or more than a reference amount of time when generating a nudge.

In some cases, the processor 430 may control the generation of a nudge if both a first condition that an app of an external device identical to an app of a specific platform is executed equal to or more than a reference number of times and a second condition that the app is executed equal to or more than a reference time are satisfied when generating a nudge.

In addition, the processor 430 can control the generation of a nudge in the form of a message that includes an app name of a specific platform that is identical to the app of the external device 500 currently being executed and a guidance text that induces the use of the app of the specific platform when generating a nudge.

Additionally, when generating a nudge, the processor 430 may display the nudge so that it overlaps the main content screen provided through the app of the external device 500.

Here, the processor 430 may display the nudge in a corner area of the entire screen of the main content when displaying the nudge, but this is only an example and is not limited thereto.

Next, the processor 430 can execute an app of the same specific platform as the app of the external device 500 that is currently executing when a user input for selecting a nudge is received.

Additionally, the processor 430 may display a nudge, measure the display time of the nudge, and stop displaying the nudge when the display time of the nudge reaches a preset reference time.

Next, when generating a nudge, the processor 430 can count the number of nudges generated, and when the number of nudges generated reaches a preset reference number, the nudge generation can be terminated.

In addition, when a nudge is generated and a user input requesting execution of an app of a specific platform is received, the processor 430 can execute an app of the same specific platform as the app of the external device 500 that is currently being executed.

In some cases, the processor 430 may display a nudge on the main content screen provided through an app of an external device 500 when a nudge is generated, and may display a platform-specific app information providing window that compares app information of a specific platform with app information of an external platform of the external device 500 on the main content screen when a user input for selecting a nudge is received.

Here, when a user input for selecting an app information item of a specific platform is received through a platform-specific app information provision window, the processor 430 can execute an app of the same specific platform as the app of the external device 500 that is currently being executed.

In another case, the processor 430 may display a nudge on the main content screen provided through an app of an external device 500 when a nudge is generated, and, when a user input for selecting a nudge is received, display a platform-specific image information provision window that compares an image provided through an app of a specific platform with an image provided through an app of an external platform of the external device 500 on the main content screen.

Here, the processor 430 can provide a platform-specific image information provision window so that an image provided through an app of a specific platform and an image provided through an app of an external platform of an external device 500 display the same content.

In addition, when a user input for selecting an image provided through an app of a specific platform is received through a platform-specific image information provision window, the processor 430 can execute an app of the same specific platform as the app of the external device 500 that is currently being executed.

In another case, the processor 430 may display a nudge on the main content screen provided through the app of the external device 500 when a nudge is generated, and may also generate and display a promotional message for an app of a specific platform around the nudge.

Here, the processor 430 can provide detailed information about an app on a specific platform when a user input for selecting a promotional message is received.

In addition, when a user input for selecting a promotional message is received, the processor 430 can execute an app of the same specific platform as the app of the external device 500 that is currently being executed.

In another case, the processor 430 may provide continuous viewing image content by executing an app of a specific platform so that image content provided through an app of an external device 500 can be continuously viewed when a nudge is generated and a user input requesting execution of an app of a specific platform is received.

Here, the processor 430 can extract an image content playback time point before the execution of an app on a specific platform, and continuously play the image content after the execution of an app on a specific platform based on the extracted image content playback time point.

In another case, the processor 430 may display a nudge on the main content screen provided through an app of an external device 500 when a nudge is generated, and may display a specific platform app experience providing window for experiencing an app of a specific platform on the main content screen when a user input for selecting a nudge is received.

Here, the processor 430 can execute an app of the same specific platform as the app of the external device 500 that is currently being executed when a user input for selecting an app experience item of a specific platform is received through a specific platform app experience provision window.

For example, a particular platform app experience provision window may provide a plurality of app experience items, including a preview item, a continue item, a resolution comparison item, a home screen item, and a recommended screen item.

In this way, the present disclosure can provide an optimal image quality service by analyzing the usage of the same app as that of a specific platform based on app execution information of an external device and generating a nudge that induces the use of an app of a specific platform.

In addition, the present disclosure can advantageously secure a user parameter of a specific platform, promote the business viability of a specific platform, secure diverse customers, and provide advertising effects for related products.

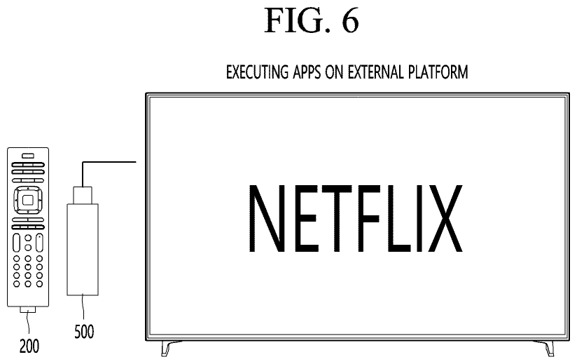

FIGS. 6 to 8 are views for explaining a process for inducing use of a specific platform app of a display device according to an embodiment of the present disclosure.

As illustrated in FIG. 6, the display device of the present disclosure, when connected to an external device 500, can provide content by executing an app of the external device 500.

Here, the present disclosure can check whether there is a request to execute an app of the external device 500 from a user through a remote control device 200 when connected to an external device 500, and if there is a request to execute an app of the external device 500, execute the app of the external device 500, and provide content on the display screen through the app of the external device 500.

At this time, the external device 500 may include a STB (Set Top Box) and an OTT (Over The Top) device, but this is only an example and is not limited thereto.

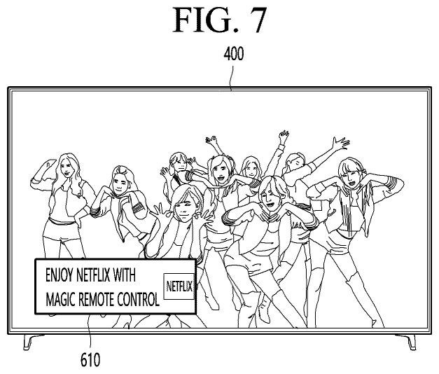

Next, as illustrated in FIG. 7, the present disclosure can obtain app execution information of an external device 500, analyze the usage of an app identical to an app of a specific platform based on the app execution information of the external device 500, and if the usage of an app identical to an app of a specific platform is equal to or greater than a reference usage, generate a nudge 610 that induces the usage of an app of a specific platform and display the nudge on the display screen of the display device 400.

Here, the present disclosure can display the nudge 610 so as to overlap on the main content screen provided through the app of the external device 500 when the nudge 610 is generated.

As an example, the present disclosure may display a nudge 610 in a corner area of the entire screen of the main content, but this is only an example and is not limited thereto.

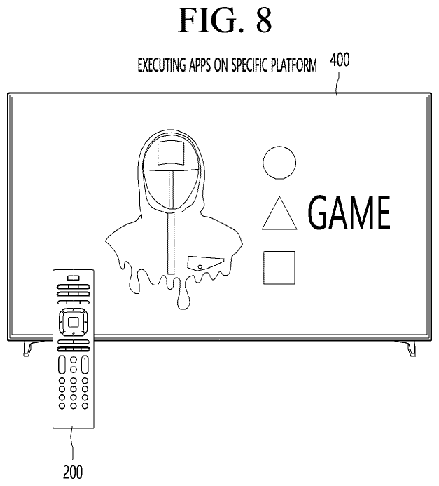

Next, as illustrated in FIG. 8, the present disclosure can execute an app of the same specific platform as the app of the external device 500 that is currently being executed when a user input selecting a nudge 610 is received.

In some cases, the present disclosure may execute an app of the same specific platform as an app of an external device 500 that is currently being executed when a user input requesting execution of an app of a specific platform is received via a remote control device 200.

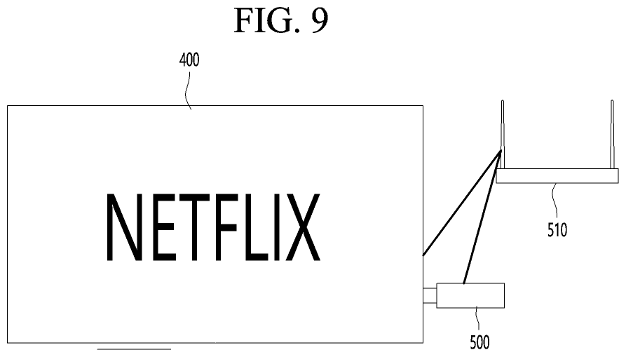

FIGS. 9 to 12 are views for explaining a process of obtaining external device app execution information of a display device according to an embodiment of the present disclosure.

As illustrated in FIG. 9, when obtaining app execution information of an external device 500, the present disclosure can obtain and store app history information of the external device 500 through an IP (Internet Protocol) network when the external device 500 is connected to the same network 510 as the display device 400, and obtain app execution information of the external device 500 based on the app history information.

Here, the present disclosure can obtain app history information including an external device name, execution app identification information, app execution count information, and app execution time information, but this is only an example and is not limited thereto.

In addition, the present disclosure can obtain app history information of an external device 500 at preset periodic intervals.

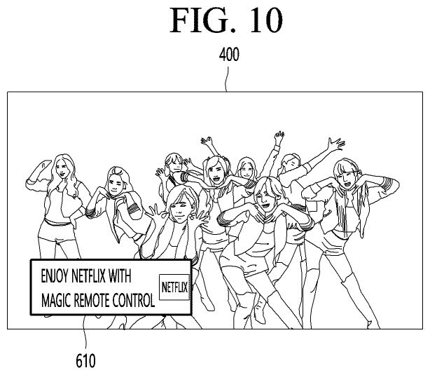

Next, as illustrated in FIG. 10, the present disclosure can check whether an app identical to an app of a specific platform exists in app execution information of an external device, and if an identical app exists, extract the number of executions and execution time for the identical app from the app execution information of the external device, and analyze the usage of the identical app based on the number of executions and execution time for the identical app.

Next, the present disclosure can generate a nudge 610 and display the nudge on the display screen of the display device 400 when an app of an external device identical to an app of a specific platform is executed equal to or more than a certain number of times or for equal to or more than a certain amount of time.

As an example, the present disclosure may display a nudge 610 so as to overlap a main content screen provided through an app of an external device when the nudge 610 is generated.

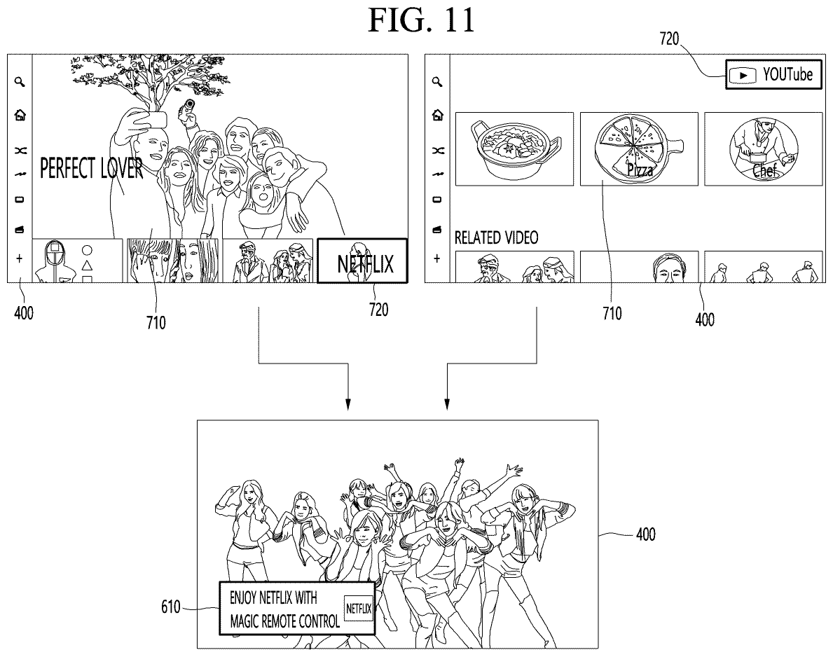

As another embodiment, as illustrated in FIG. 11, when obtaining app execution information of an external device, the present disclosure can provide a content image 710 through an app of the external device, and when the external device recognizes the content image 710 and extracts a feature 720 of a specific app from the content image 710, obtain and store the app history information executed by the user based on the extracted feature 720 of the specific app, and obtain the app execution information of the external device based on the app history information.

Here, the present disclosure can confirm whether a feature 720 of a specific app is extracted through content image recognition of an external device, determine that a specific app is being executed if the feature 720 of the specific app is extracted, and obtain and store app history information for the specific app.

For example, the characteristics 720 of a specific app may include the execution app identification information included in the content image 710.

Accordingly, the present disclosure can check whether an image analysis function exists in an external device, and if the image analysis function exists in the external device, check whether features of a specific app are extracted through content image recognition of the external device.

As an example, the present disclosure can obtain installation function information from an external device and check whether an image analysis function exists in the external device based on the installation function information.

Next, the present disclosure can generate a nudge 610 and display the nudge on the display screen of the display device 400 when an app of an external device identical to an app of a specific platform is executed equal to or more than a certain number of times or for equal to or more than a certain amount of time.

As an example, the present disclosure may display a nudge 610 so as to overlap a main content screen provided through an app of an external device when the nudge 610 is generated.

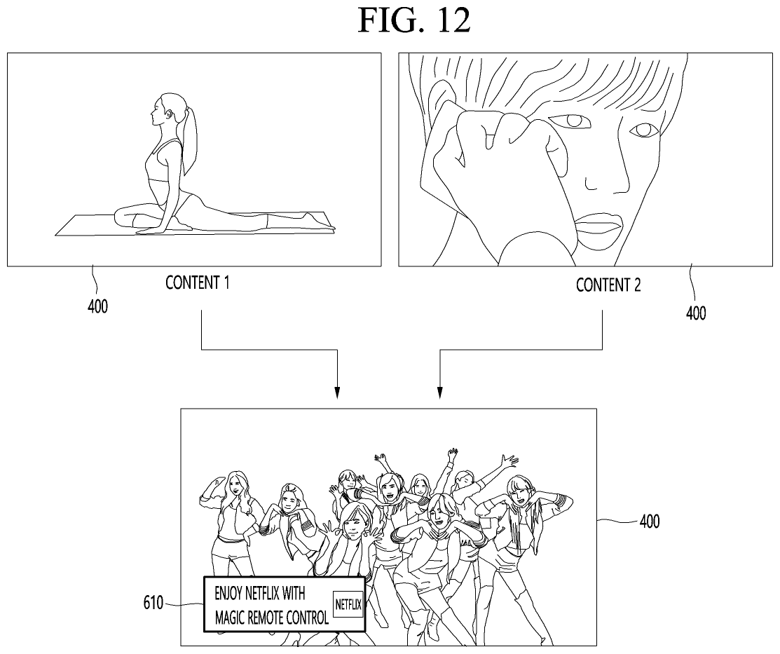

As another embodiment, as illustrated in FIG. 12, when obtaining app execution information of an external device, the present disclosure can provide a content image through an app of the external device, recognize the content image and extracts identification information from the content image, obtain and store app history information executed by the user based on the extracted identification information, and obtain app execution information of the external device based on the app history information.

Here, the present disclosure can recognize a content image using an ACR (Automatic Content Recognition) algorithm and extract identification information from the recognized content image.

As an example, the present disclosure can extract identification information from content images using a watermarking method or a fingerprinting method.

Next, the present disclosure can generate a nudge 610 and display the nudge on the display screen of the display device 400 when an app of an external device identical to an app of a specific platform is executed equal to or more than a certain number of times or for equal to or more than a certain amount of time.

As an example, the present disclosure may display a nudge 610 so as to overlap a main content screen provided through an app of an external device when the nudge 610 is generated.

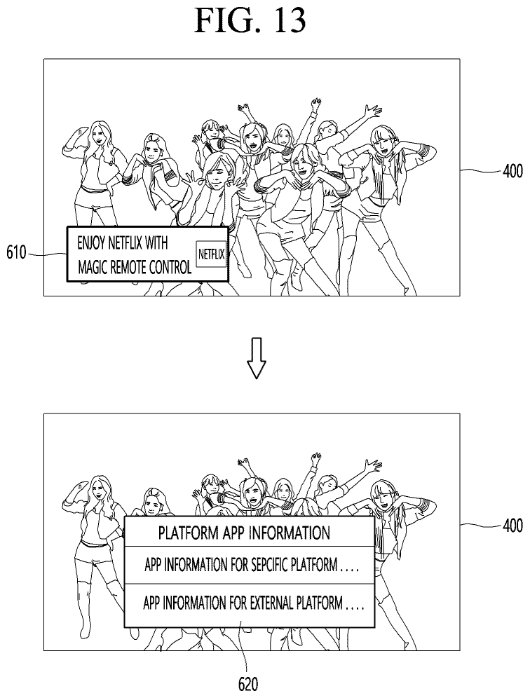

FIG. 13 is a view for explaining a process of displaying a platform-specific app information provision window of a display device according to one embodiment of the present disclosure.

As illustrated in FIG. 13, the present disclosure can display a nudge 610 on a main content screen provided through an app of an external device when a nudge 610 is generated, and, when a user input for selecting the nudge 610 is received, display a platform-specific app information provision window 620 that compares app information of a specific platform with app information of an external platform of an external device on the main content screen.

Here, the present disclosure can execute an app of a specific platform that is identical to an app of an external device that is currently being executed when a user input for selecting an app information item of a specific platform is received through a platform-specific app information provision window 620.

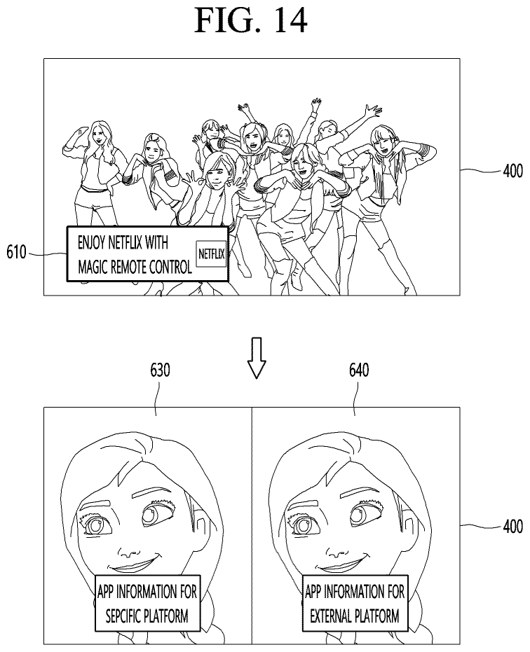

FIG. 14 is a view for explaining a process of displaying a platform-specific image information provision window of a display device according to one embodiment of the present disclosure.

As illustrated in FIG. 14, the present disclosure can display a nudge 610 on a main content screen provided through an app of an external device when a nudge 610 is generated, and, when a user input for selecting the nudge 610 is received, display a platform-specific video information provision window on the main content screen that compares an image 630 provided through an app of a specific platform and an image 640 provided through an app of an external platform of the external device.

Here, the present disclosure can provide a platform-specific video information provision window so that an image 630 provided through an app of a specific platform and an image 640 provided through an app of an external platform of an external device display the same content.

In addition, the present disclosure can execute an app of a specific platform that is identical to an app of an external device that is currently being executed when a user input for selecting an image provided through an app of a specific platform is received through a platform-specific image information provision window.

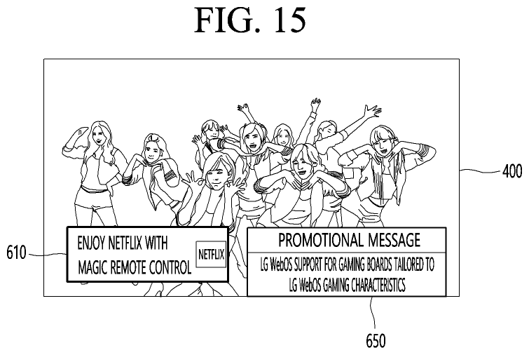

FIG. 15 is a view for explaining a process of displaying a specific platform promotional message of a display device according to one embodiment of the present disclosure.

As illustrated in FIG. 15, the present disclosure can display a nudge 610 on a main content screen provided through an app of an external device when a nudge 610 is generated, and also generate and display a promotional message 650 for an app of a specific platform around the nudge 610.

Here, the present disclosure can provide detailed information about an app on a particular platform when a user input is received selecting a promotional message 650.

In addition, the present disclosure can execute an app of the same specific platform as the app of the external device that is currently running when a user input of selecting a promotional message 650 is received.

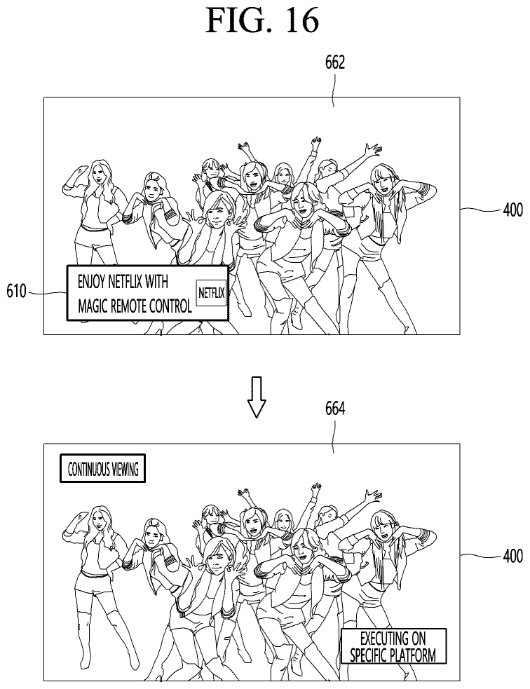

FIG. 16 is a view for explaining a process of providing continuous viewing image content through execution of a specific platform app of a display device according to an embodiment of the present disclosure.

As illustrated in FIG. 16, the present disclosure can provide continuous viewing image content 664 through execution of an app on a specific platform so that image content 662 provided through an app on an external device can be continuously viewed when a nudge 610 is generated and a user input requesting execution of an app on a specific platform is received.

Here, the present disclosure extracts an image content playback time prior to execution of an app on a specific platform, and can continuously play the image content after execution of an app on a specific platform based on the extracted image content playback time.

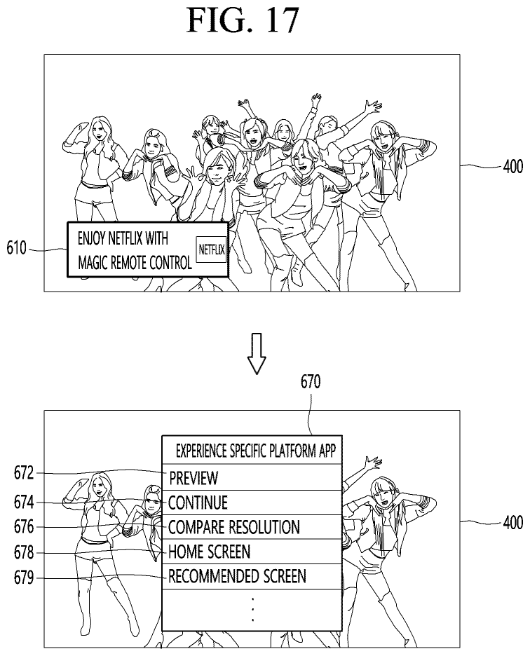

FIG. 17 is a view for explaining a process of displaying a specific platform app experience provision window of a display device according to one embodiment of the present disclosure.

As illustrated in FIG. 17, the present disclosure can display a nudge 610 on a main content screen provided through an app of an external device when a nudge 610 is generated, and can display a specific platform app experience provision window 670 for experiencing an app of a specific platform on the main content screen when a user input for selecting the nudge 610 is received.

Here, the present disclosure can execute an app of the same specific platform as an app of an external device that is currently being executed when a user input for selecting an app experience item of a specific platform is received through a specific platform app experience provision window 670.

For example, a specific platform app experience provision window 670 may provide a plurality of app experience items including a preview item 672, a continue item 674, a resolution comparison item 676, a home screen item 678, and a recommended screen item 679.

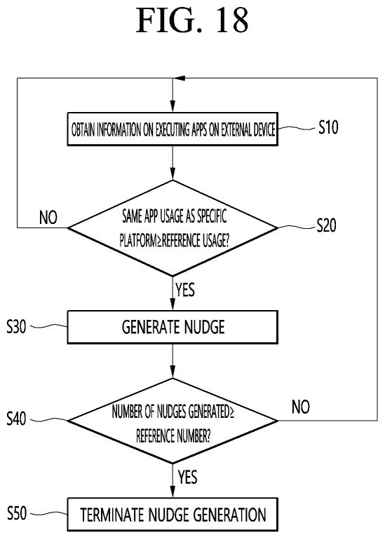

FIG. 18 is a flowchart illustrating a process for inducing use of a specific platform app of a display device according to an embodiment of the present disclosure.

As illustrated in FIG. 18, the present disclosure can provide image content by executing an app on an external device.

Next, the present disclosure can obtain app execution information of an external device (S10).

Next, the present disclosure can analyze the usage of an app identical to an app on a specific platform based on app execution information of an external device to check whether the usage of an app identical to an app on a specific platform is equal to or greater than a reference usage (S20).

In addition, the present disclosure can generate a nudge that induces the use of an app on a specific platform if the usage of the same app on a specific platform is equal to or more than the reference usage (S30).

Here, the present disclosure may display a nudge, measure the display time of the nudge, and stop displaying the nudge when the display time of the nudge reaches a preset reference time.

Next, the present disclosure can count the number of nudges created when a nudge is created and determine whether the number of nudges created is equal to or greater than a preset reference number (S40).

Next, the present disclosure can terminate nudge generation if the number of nudge generation times is equal to or greater than a preset reference number (S50).

In addition, the present disclosure can execute an app of the same specific platform as an app of an external device that is currently being executed when a user input requesting execution of an app of a specific platform is received.

In this way, the present disclosure can provide an optimal image quality service by analyzing the usage of the same app as that of a specific platform based on app execution information of an external device and generating a nudge that induces the use of an app of a specific platform.

In addition, the present disclosure can advantageously secure a user parameter of a specific platform, promote the business viability of a specific platform, secure diverse customers, and provide advertising effects for related products.

The above-described present disclosure can be implemented as a computer-readable code on a medium in which a program is recorded. The computer-readable medium includes all kinds of recording devices in which data that can be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include a processor 180 of an artificial intelligence device.

### INDUSTRIAL APPLICABILITY

According to the display device according to the present disclosure, there is an effect of being able to provide an optimal image quality service by analyzing the usage of the same app as that of an app of a specific platform based on app execution information of an external device and generating a nudge to induce the use of the app of a specific platform, so that the display device has remarkable industrial applicability.

1. A display device comprising:
a communication part connected to an external device;
a nudge generation part generating a nudge that induces a use of an app of a specific platform; and,
a processor controlling the nudge generation part,
wherein the processor,
when connected to the external device, executes an app of the external device to provide content, obtains app execution information of the external device, analyzes the usage of the same app as the app of the specific platform based on the app execution information of the external device, and controls the nudge generation part to generate a nudge that induces the use of the app of the specific platform if the usage of the same app as the app of the specific platform is equal to or greater than a reference usage.

2. The display device of claim 1,
wherein the processor,
when providing the content, if connected to the external device, checks whether there is an app execution request of the external device, and if there is an app execution request of the external device, executes the app of the external device, and provides the content on the display screen through the app of the external device.

3. The display device of claim 1,
wherein the processor,
when obtaining app execution information of the external device, if the external device is connected to the same network as the display device, obtains and stores app history information of the external device through an IP (Internet Protocol) network, and obtains app execution information of the external device based on the app history information.

4. The display device of claim 1,
wherein the processor,
when obtaining app execution information of the external device, provides a content image through the app of the external device, and when the external device recognizes the content image and extracts a feature of a specific app from the content image, obtains and stores app history information executed by the user based on the extracted feature of the specific app, and obtains app execution information of the external device based on the app history information.

5. The display device of claim 1,
wherein the processor,
when obtaining app execution information of the external device, provides a content image through the app of the external device, recognizes the content image and extracts identification information from the content image, obtains and stores app history information executed by the user based on the extracted identification information, and obtains app execution information of the external device based on the app history information.

6. The display device of claim 1,
wherein the processor,
when analyzing the app usage, checks whether an app identical to the app of the specific platform exists in the app execution information of the external device, and if the identical app exists, extracts the number of executions and execution time for the identical app from the app execution information of the external device, and analyzes the usage of the identical app based on the number of executions and execution time for the identical app.

7. The display device of claim 1,
wherein the processor,
when generating the nudge, if the app of the external device identical to the app of the specific platform is executed equal to or more than a reference number of times or is executed equal to or more than a reference time, controls the generation of the nudge.

8. The display device of claim 1,
wherein the processor,
when generating the nudge, if both a first condition that the app of the external device identical to the app of the specific platform is executed a reference number of times or more and a second condition that the app is executed a reference time or more are satisfied, controls the generation of the nudge.

9. The display device of claim 1,
wherein the processor,
when generating the nudge, controls the generation of a nudge in the form of a message including the name of an app of the specific platform that is identical to the app of the external device currently executing and a guidance text that induces the use of the app of the specific platform.

10. The display device of claim 1,
wherein the processor,
when generating the nudge, if the nudge is generated, displays the nudge to overlap on the main content screen provided through the app of the external device.

11. The display device of claim 10,
wherein the processor,
when a user input for selecting the nudge is received, executes the app of the specific platform that is identical to the app of the external device that is currently being executed.

12. The display device of claim 10,
wherein the processor displays the nudge, measures the display time of the nudge, and, when the display time of the nudge reaches a preset reference time, stops displaying the nudge.

13. The display device of claim 1,
wherein the processor,
when generating the nudge, if the nudge is generated, counts the number of nudges generated, and, when the number of nudges generated reaches a preset reference number, terminates the nudge generation.

14. The display device of claim 1,
wherein the processor,
when the nudge is generated and a user input requesting execution of the app of the specific platform is received, executes the app of the specific platform that is identical to the app of the external device that is currently being executed.

15. A method for inducing use of a specific platform app of a display device comprising:
connecting to an external device;
providing image content by executing an app of the external device;
obtaining app execution information of the external device;
analyzing the usage of an app identical to the app of the specific platform based on the app execution information of the external device; and
if the same app usage as the app on the specific platform is equal to or greater than a reference usage, generating a nudge that induces use of the app of the specific platform.
